(19) United States
(12) Patent Application Publication
(10) Pub. No.: US 2001/0033617 A1
(43) Pub. Date: Oct. 25, 2001

(54) Image processing device

(76) Inventors: Fumitoshi Karube, Tokyo (JP); Toshihisa Kamemaru, Tokyo (JP); Hirokazu Suzuki, Tokyo (JP)

Correspondence Address: BIRCH STEWART KOLASCH & BIRCH, PO BOX 747, FALLS CHURCH, VA, 22040-0747, US

(21) Appl. No.: 09/820,315

(22) Filed: Mar. 29, 2001

(30) Foreign Application Priority Data
Apr. 19, 2000 (JP) 2000-118434

(51) Int. Cl. H04N 7/12; H04N 7/30; H04N 7/32

(52) U.S. Cl. 375/240.12; 375/240.2; 375/240.03; 375/240.23; 348/714; 348/716; 348/718

(57) ABSTRACT

An image processing device comprises an SIMD (Single Instruction stream Multiple Data stream) calculating unit (101) for performing operations, such as motion compensation, motion prediction, DCT (Discrete Cosine Transform) processing, IDCT (Inverse Discrete Cosine Transform) processing, quantization, and reverse quantization by means of a pipeline operation unit that can be program-controlled by an outside unit, a VLC (Variable Length Code) processing unit (102) for performing variable-length encoding processing and variable-length decoding processing according to a given encoding method, an external data interface (103) for performing a data transfer between the image processing device and an outside unit, and a processor (105) for decoding an instruction held by an instruction memory (104), and for performing a programmed control operation on the SIMD calculating unit (101), the VLC processing unit (102), and the external data interface (103).

### BACKGROUND OF THE INVENTION

1. Field of the Invention

The present invention relates to an image processing device adaptable to various encoding methods.

2. Description of the Prior Art

FIG. 9 is a block diagram showing the structure of a prior art image processing device disclosed in, for example, “MPEG-4 LSI, Internet, and Broadcast Services”, Journal of the Institute of Image Information and Television Engineers, Vol. 53, No. 4, 1999, for example. In FIG. 9, reference numeral 201 denotes an instruction memory for storing a program, numeral 202 denotes a VLE (Variable Length Encode) unit for performing a variable-length encoding, numeral 203 denotes a VLD (Variable Length Decode) unit for performing a variable-length decoding, numeral 204 denotes a memory provided by the VLD unit 203, numeral 205 denotes a motion compensation unit for performing motion compensation processing, numeral 206 denotes a motion prediction unit A for performing motion prediction processing, numeral 207 denotes a motion prediction unit B for performing motion prediction processing, numeral 208 denotes a DCT (Discrete Cosine Transform) unit for performing DCT processing, and numeral 209 denotes an IDCT (Inverse Discrete Cosine Transform) unit for performing IDCT processing.

Furthermore, in FIG. 9, reference numeral 220 denotes an external memory for holding the value of a picture signal, numerals 230a to 230f denote local memories built in a processor 211, which will be described below, the motion compensation unit 205, the motion prediction unit A 206 and the motion prediction unit B207, the DCT unit 208, and the IDCT unit 209, respectively, and numeral 210 denotes a DMA (Direct Memory Access) control unit for controlling those local memories 230a to 230f and the external memory 220. The processor 211 can control the VLE unit 202, the VLD unit 203, and the DMA control unit 210.

In operation, when the prior art image processing device performs processing such as the motion compensation processing, the motion prediction processing, the DCT processing, or the IDCT processing, a specific block actually carries out the processing. That is, the motion compensation unit 205 carries out the motion compensation processing, the motion prediction units A and B 206 and 207 carry out the motion prediction processing, the DCT unit 208 carries out the DCT processing, or the IDCT unit 209 carries out the IDCT processing. Furthermore, when the prior art image processing device performs quantization processing, the processor 211 carries out the quantization processing.

A problem with the prior art image processing device constructed as above is that the motion compensation unit 205, the motion prediction unit A 206, the motion prediction unit B 207, the DCT unit 208, and the IDCT unit 209 are blocks specific to the algorithm of a given encoding method, and therefore the prior art image processing device cannot support various encoding methods. Furthermore, another problem is that since when performing the quantization processing not a block specific to the quantization but the processor 211 carries out the quantization processing, a number of clock cycles required for the quantization processing is increased.

### SUMMARY OF THE INVENTION

The present invention is proposed to solve the above-mentioned problems, and it is therefore an object of the present invention to provide an image processing device that can support various encoding methods and reduce the number of clock cycles required for the image processing.

In accordance with an aspect of the present invention, there is provided an image processing device comprising: an SIMD (Single Instruction stream Multiple Data stream) calculating unit for performing operations, such as motion compensation, motion prediction, DCT processing, IDCT processing, quantization, and reverse quantization by means of a pipeline operation unit that can be program-controlled by an outside unit; a VLC (Variable Length Code) processing unit for performing variable-length encoding processing and variable-length decoding processing according to a given encoding method; an external data interface for performing a data transfer between the image processing device and an outside unit; an instruction memory for holding an instruction to be processed; and a processor for decoding the instruction held by the instruction memory, and for performing a programmed control operation on the SIMD calculating unit, the VLC processing unit, and the external data interface. The image processing device can thus support various encoding methods, and can reduce the number of clock cycles required for image processing.

In accordance with another aspect of the present invention, the image processing device includes a RAM as the instruction memory. The image processing device can thus support various encoding methods with the single LSI.

In accordance with a further aspect of the present invention, the image processing device includes a ROM as the instruction memory. Thus, the area of the LSI can be reduced and the cost of the image processing device can be reduced.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of an image processing device according to a first embodiment of the present invention;

FIG. 2 is a flow chart showing processing performed by the image processing device according to the first embodiment of the present invention;

FIG. 3 is a block diagram showing the structure of an SIMD calculating unit of the image processing device according to the first embodiment of the present invention;

FIG. 4 is a diagram showing the elements of two matrices which are multiplied with each other, the product of the matrices being calculated by the SIMD calculating unit, as shown in FIG. 3, of the image processing device according to the first embodiment of the present invention;

FIG. 5 is a diagram showing a pipeline operation of the SIMD calculating unit, as shown in FIG. 3, of the image processing device according to the first embodiment of the present invention when performing the multiplication of the two matrices as shown in FIG. 4;

FIG. 6 is a graph showing a comparison between the number of clock cycles required for only a general-purpose processor to perform image processing on each macro block, and the number of clock cycles required for a VLC processing unit to perform the image processing on each macro block in cooperation with the general-purpose processor;

FIG. 7 is a graph showing a comparison between the number of clock cycles required for only a general-purpose processor to perform the image processing on each macro block, and the number of clock cycles required for the SIMD calculating unit to perform the image processing on each macro block in cooperation with the general-purpose processor;

FIG. 8 is a graph showing a comparison between the number of clock cycles required for only a general-purpose processor to perform the image processing on each macro block, and the number of clock cycles required for both the VLC processing unit and the SIMD calculating unit of the image processing device according to the first embodiment of the present invention to perform the image processing on each macro block in cooperation with the general-purpose processor; and

FIG. 9 is a block diagram showing the structure of a prior art image processing device.

### DETAILED DESCRIPTION OF THE PREFERRED EMBODIMENTS

### Embodiment 1

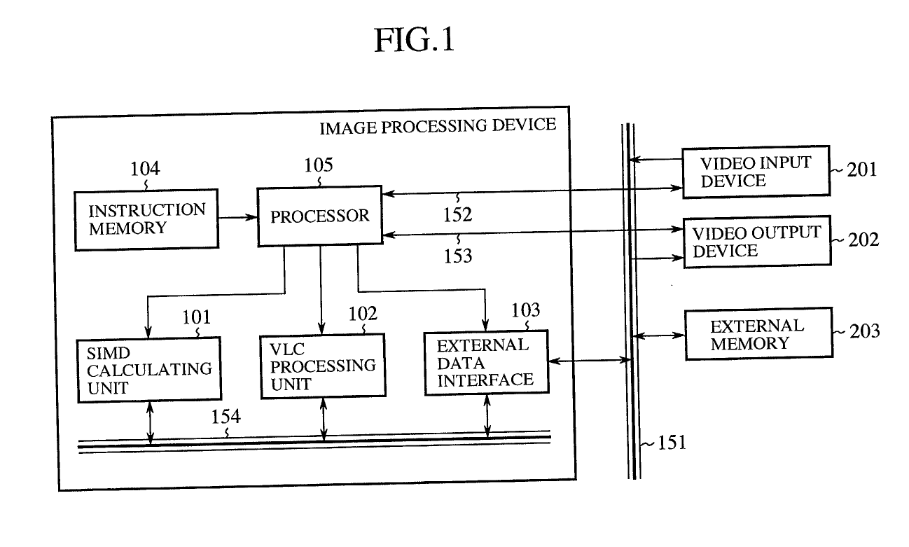

FIG. 1 is a block diagram showing the structure of an image processing device according to a first embodiment of the present invention. In the figure, reference numeral 101 denotes an SIMD (Single Instruction stream Multiple Data stream) calculating unit for performing operations, such as motion compensation, motion predictions, DCT processing, IDCT processing, quantization, and reverse quantization by means of a pipeline operation device that can be program-controlled by an outside unit, numeral 102 denotes a VLC processing unit for performing variable-length encoding processing and variable-length decoding processing according to a given encoding method, and numeral 103 denotes an external data interface for performing a data transfer between the image processing device and an outside unit.

Furthermore, in FIG. 1, reference numeral 104 denotes an instruction memory for holding an instruction to be processed by the image processing device, and numeral 105 denotes a processor for performing a scalar calculating operation, a bit handling operation, for executing a comparison instruction and a branch instruction, for decoding the instruction held by the instruction memory 104, and for controlling the SIMD calculating unit 101, the VLC processing unit 102, the external data interface 103, a video input device 201 which will be described below, and a video output device 202 which will be described below. The video input device 201 of FIG. 1 can accept a video signal from an outside unit, and the video output device 202 can deliver a video signal to an outside unit. An external memory 203 can hold a video signal from either the video input device 201 or the external data interface 103.

In addition, in FIG. 1, reference numeral 151 denotes a 32-bit video data bus for connecting the external data interface 103 to the video input device 201, the output device 202, and the external memory 203, numerals 152 and 153 denote I/O control signals that pass through a line for connecting the processor 105 to the video input device 201 and a line for connecting the processor 105 and the video output device 202, respectively, for controlling the input/output of a video signal, and numeral 154 denotes a 32-bit internal data bus for connecting the SIMD calculating unit 101, the VLC processing unit 102, and the external data interface 103 with one another.

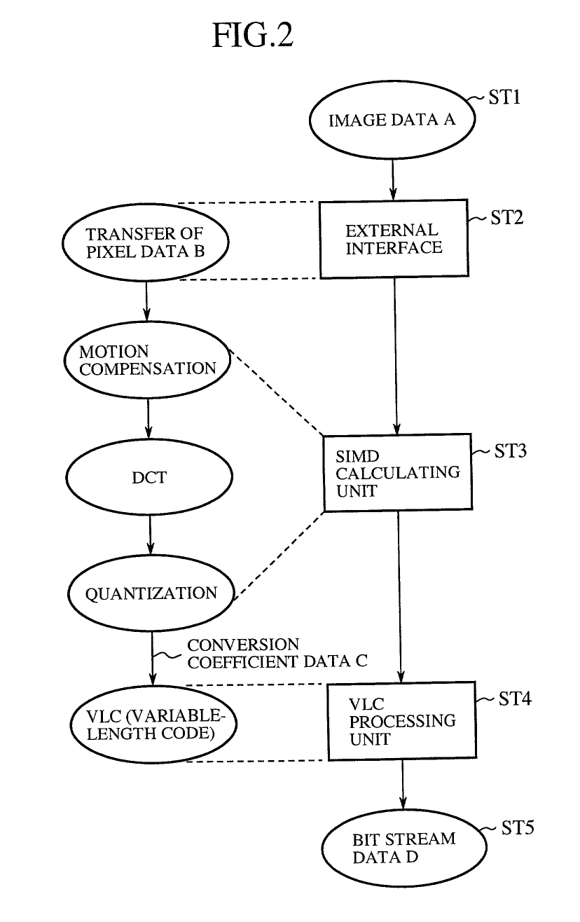

FIG. 2 is a flow chart showing the encoding processing performed by the image processing device according to the first embodiment of the present invention. The image processing device transmits image data A from the video input device 201 to the external memory 203 in step ST1. The image processing device then, in step ST2, transmits necessary pixel data B of the image data A from the external memory 203 to the external data interface 103 according to the processing done by the SIMD calculating unit 101. The SIMD calculating unit 101, in step ST3, performs motion compensation, DCT processing, and quantization so as to obtain conversion coefficient data C. The VLC processing unit 102, in step ST4, converts the conversion coefficient data C to a variable-length code. The VLC processing unit 102 then, in step ST5, outputs bit stream data D as the result of the processing of step ST4.

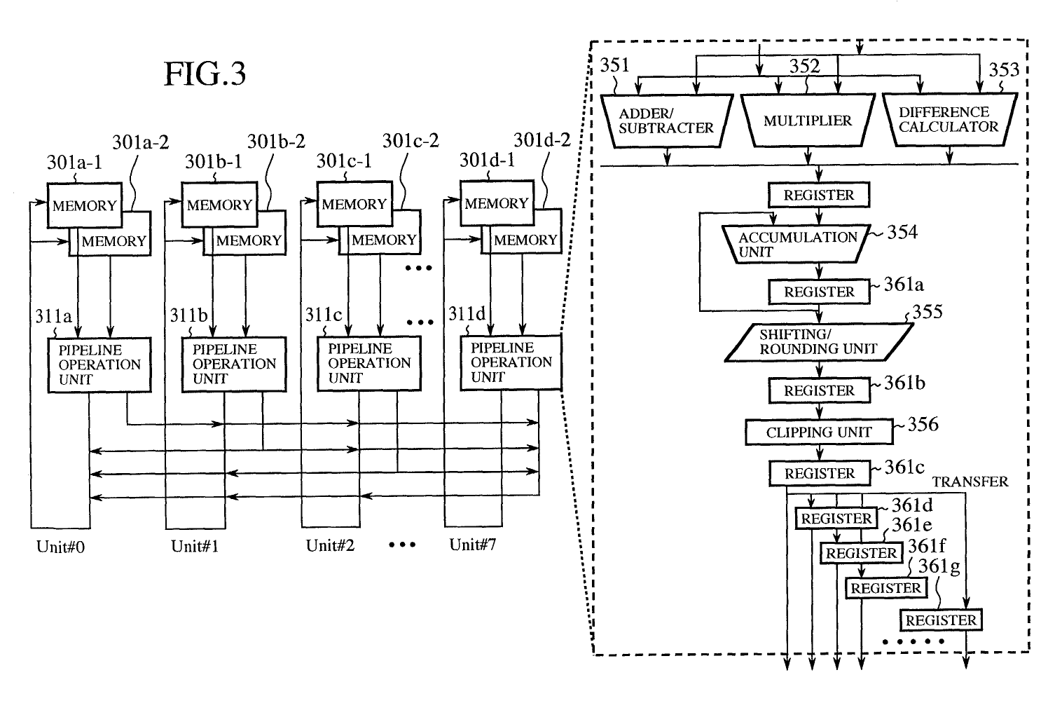

Next, a description will be made as to the multiplication of two matrices with 8 rows and 8 columns, as an example of the encoding processing which is carried out during the DCT processing done by the SIMD calculating unit 101. FIG. 3 is a block diagram showing the structure of the SIMD calculating unit that consists of 16 memories in parallel and 8 pipeline calculating units in parallel. In the figure, reference numerals 301a-1, 301a-2, 301b-1, 301b-2, 301c-1, 301c-2, . . . , 301d-1 and 301d-2 denote 16 memories in parallel, respectively, and 311a, 311b, 311c, . . . , and 311d denote 8 pipeline calculating units in parallel, respectively. The SIMD calculating unit is divided into 8 units: Unit#0 to Unit#7. Unit#0 consists of the two memories 301a-1 and 301a-2 and the pipeline calculating unit 311a, and either of Unit#1, Unit#2, . . . , and Unit#7 consists of two memories and one pipeline calculating unit in the same way.

Furthermore, each of the eight pipeline calculating units of FIG. 3 includes an adder/subtracter 351 for performing an addition operation and a subtraction operation, a multiplier 352 for performing a multiplication operation, a difference calculator 353 for performing a difference operation, an accumulator 354 for performing an accumulation operation, a shifting/rounding unit 355 for performing a shift operation and a round operation, a clipping unit 356 for performing a clipping operation, and registers 361a to 361g each for holding an operation result.

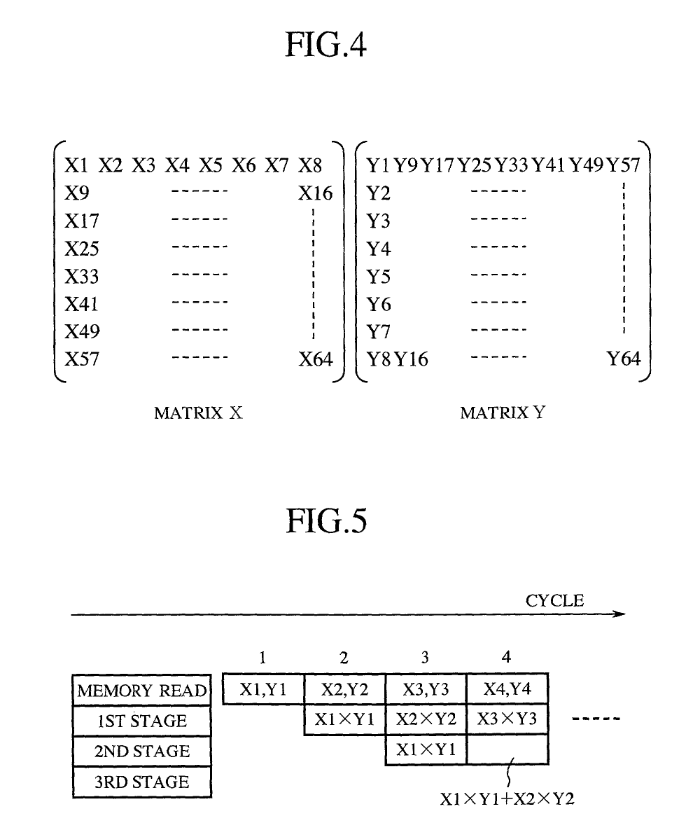

FIG. 4 is a diagram showing the elements of a matrix X and the elements of a matrix Y, on which an operation of matrix multiplication is performed. Before calculating the sum of the products which are obtained by multiplying element-by-element each of all the elements in the first row of the matrix X with a corresponding one of all the elements in the first column of the matrix Y, all the elements in the first row of the matrix X, i.e., X1, X2, . . . , and X8 are held in each of the memories 301a-1, 301b-1, 301c-1, . . . , and 301d -1. The memory 301a-2 holds all the elements in the first column of the matrix Y, i.e., Y1, Y2, . . . , and Y8, the memory 301a-2 holds all the elements in the second column of the matrix Y, i.e., Y9, Y10, . . . , and Y16, and in the same way, the remaining memories 301c-2, and 301d-2 hold all the elements in the third to eighth columns of the matrix Y, respectively.

Unit#0 then calculates the sum of the element-by-element products of each of all the elements in the first row of the matrix X and a corresponding one of all the elements in the first column of the matrix Y. Unit#1 calculates the sum of the element-by-element products of each of all the elements in the first row of the matrix X and a corresponding one of all the elements in the second column of the matrix Y. In the same way, Unit#i (i=2 to 7) calculates the sum of the element-by-element products of each of all the elements in the first row of the matrix X and a corresponding one of all the elements in the (i+1)th column of the matrix Y.

FIG. 5 is a diagram showing the pipeline operation of Unit#0 when the SIMD calculating unit 101 performs the multiplication of two 8 by 8 matrices as shown in FIG. 4. In the first cycle of the pipeline operation, Unit#0 transfers the element X1 of the matrix X from the memory 301a-1 to the pipeline operation unit 311a, and also transfers the element Y1 of the matrix Y from the memory 301a-2 to the pipeline operation unit 311a. In the second cycle of the pipeline operation, the multiplier 352 of the pipeline operation unit 311a then performs the multiplication of X1 and Y1, and Unit#0 simultaneously transfers the element X2 of the matrix X from the memory 301a-1 to the pipeline operation unit 311a, and also transfers the element Y2 of the matrix Y from the memory 301a-2 to the pipeline operation unit 311a. In the third cycle of the pipeline operation, the multiplier 352 of the pipeline operation unit 311a then performs the multiplication of X2 and Y2, and Unit#0 simultaneously transfers the element X3 of the matrix X from the memory 301a-1 to the pipeline operation unit 311a, and also transfers the element Y3 of the matrix Y from the memory 301a-2 to the pipeline operation unit 311a. In the fourth cycle of the pipeline operation, the accumulator 354 of the pipeline operation unit 311a calculates the sum of X1*Y1 and X2*Y2. In the same cycle, the multiplier 352 of the pipeline operation unit 311a performs the multiplication of X3 and Y3, and Unit#0 simultaneously transfers the element X4 of the matrix X from the memory 301a-1 to the pipeline operation unit 311a, and also transfers the element Y4 of the matrix Y from the memory 301a-2 to the pipeline operation unit 311a.

In the same way that Unit#0 calculates the sum of the element-by-element products of each of all the elements in the first row of the matrix X and a corresponding one of all the elements in the first column of the matrix Y, each of Unit#1 to Unit#7 performs a similar operation. The SIMD calculating unit performs the multiplication of the two 8 by 8 matrices by repeating the above-mentioned processes by means of Unit#0 to Unit#7.

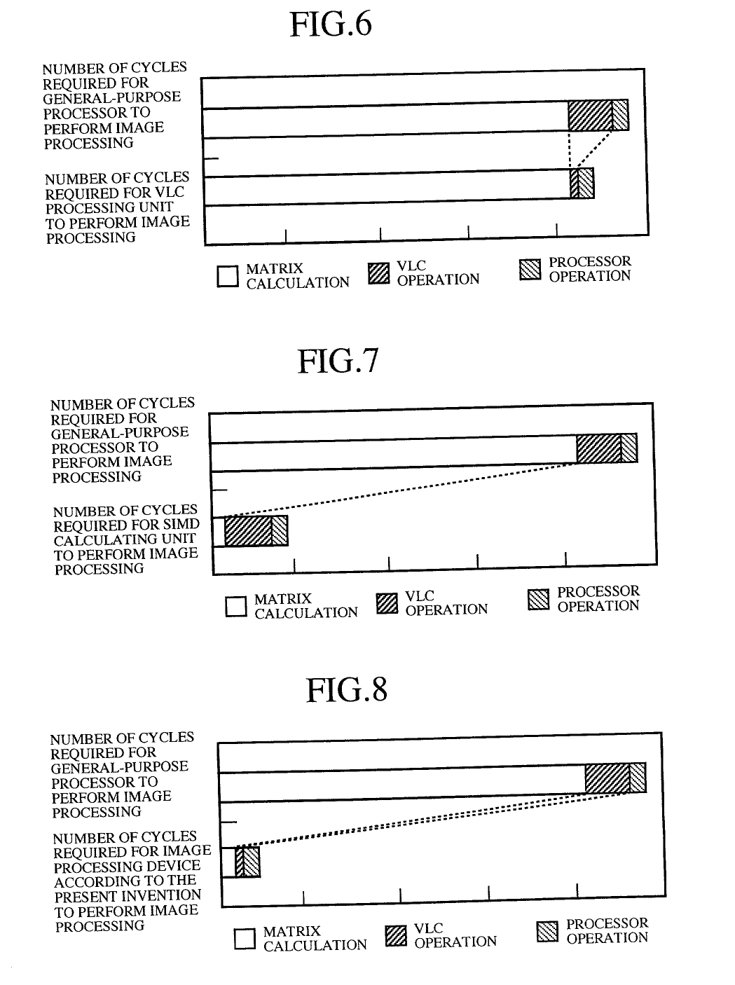

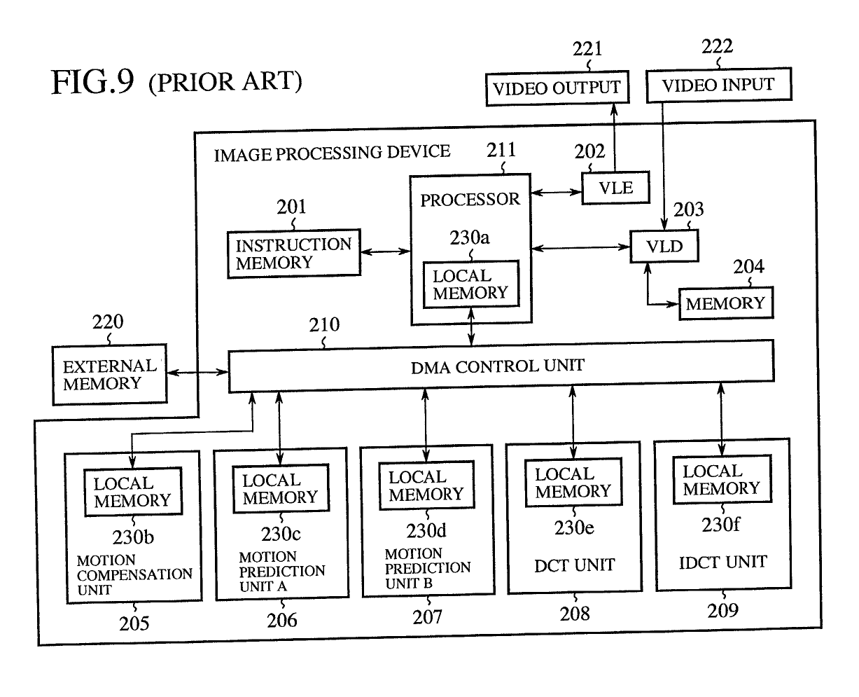

Next, the number of clock cycles required for image processing will be explained. In general, a function of supporting various encoding methods is implemented via a general-purpose processor. FIG. 6 is a graph showing a comparison between the number of clock cycles required for only a general-purpose processor, such as the processor 105, to perform image processing on each macro block, and the number of clock cycles required for the VLC processing unit 102 to perform the image processing on each macro block in cooperation with the general-purpose processor. Although the number of clock cycles required for the image processing can be reduced by using the VLC processing unit 102 as can be seen from FIG. 6, a lot of clock cycles is needed for the matrix calculating operation and the reduction is not good enough.

FIG. 7 is a graph showing a comparison between the number of clock cycles required for only a general-purpose processor to perform image processing on each macro block, and the number of clock cycles required for the SIMD calculating unit 101 to perform the image processing on each macro block in cooperation with the general-purpose processor. Although the number of clock cycles required for the image processing can be reduced by using the SIMD calculating unit 101 as can be seen from FIG. 7, a lot of clock cycles is needed for the VLC calculating operation and the reduction is not good enough.

FIG. 8 is a graph showing a comparison between the number of clock cycles required for only a general-purpose processor to perform image processing on each macro block, and the number of clock cycles required for the VLC processing unit 102 and the SIMD calculating unit 101 to perform the image processing on each macro block in cooperation with the general-purpose processor. The number of clock cycles required for the image processing can be reduced sufficiently by using both the VLC processing unit 102 and the SIMD calculating unit 101 together with the general-purpose processor, as can be seen from FIG. 8.

The image processing device constructed as above can support various encoding methods because the processor 105 decodes a program used for controlling the SIMD calculating unit 101, the VLC processing unit 102, and the external data interface 103, which has been read out of the instruction memory 104, and the image processing device therefore performs programmed control of the SIMD calculating unit 101, the VLC processing unit 102, and the external data interface 103.

While a prior art image processing device includes a DCT unit and an IDCT unit disposed separately, the image processing device of the present embodiment implements DCT processing and IDCT processing by using only the SIMD calculating unit 101 because both the DCT processing and the IDCT processing are not carried out at the same time, thus reducing the amount of hardware.

In addition, while when the prior art image processing device performs motion compensation, a motion compensation unit, a motion prediction unit A, and a motion prediction unit B of the prior art image processing device can operate at the same time, the SIMD calculating unit 101 of the image processing device of the present embodiment can perform motion compensation at a high speed even though the SIMD calculating unit 101 is a single block because the SIMD calculating unit 101 can process image data in parallel.

An adaptive video signal processor disclosed in Japanese patent application publication No. 6-292178 and a programmable processor disclosed in Japanese patent application publication No. 8-50575 are conventional technologies that relate to the present invention. However, neither of them includes any unit which corresponds to the VLC processing unit 102 according to the first embodiment. Since in the image processing device according to the present embodiment the SIMD calculating unit 101 and the VLC processing unit 102 can operate in parallel, the image processing device can implement image processing efficiently with a fewer number of clock cycles.

As mentioned above, in accordance with the first embodiment of the present invention, the image processing device includes the SIMD calculating unit 101 for performing operations, such as motion compensation, motion prediction, DCT processing, IDCT processing, quantization, and reverse quantization, and the VLC processing unit 102 for performing variable-length encoding processing and variable-length decoding processing according to a given encoding method. The image processing device of the first embodiment can thus support various encoding methods, and can reduce the number of clock cycles required for image processing.

### Embodiment 2

An image processing device according to a second embodiment of the present invention includes a RAM (Random Access Memory) into which instructions can be downloaded from outside the image processing device as the instruction memory 104 shown in FIG. 1. The other structure of the image processing device according to the second embodiment is the same as that of the image processing device according to the first embodiment. The image processing device according to the second embodiment operates in the same way that the image processing device according to the first embodiment does, with the exception that instructions are downloaded into the RAM.

As mentioned above, in accordance with the second embodiment of the present invention, since the image processing device includes the RAM into which instructions can be downloaded from outside the image processing device, the image processing device can support various encoding methods with the single LSI.

### Embodiment 3

An image processing device according to a third embodiment of the present invention includes a low-cost small-size ROM (Read Only Memory) as the instruction memory 104 shown in FIG. 1. The other structure of the image processing device according to the third embodiment is the same as that of the image processing device according to the first embodiment. The image processing device according to the third embodiment operates in the same way that the image processing device according to the first embodiment does.

As mentioned above, in accordance with the third embodiment of the present invention, since the image processing device includes the ROM, the area of the LSI can be reduced and the cost of the image processing device can be reduced.

In the above-mentioned embodiments, coding processing is described as an example of the operation of the image processing device. However, the present invention is not limited to the image processing device for performing coding processing, and the image processing device of the present invention can also perform decoding processing.

In the above-mentioned first embodiment, DCT processing is illustrated as an example of the operation of the SIMD calculating unit 101. However, it is needless to say that the SIMD calculating unit 101 can carry out processing such as motion prediction, IDCT processing, quantization, reverse-quantization, or a filter generation, by means of the adder/subtracter 351, the multiplier 352, the difference calculating unit 353, the accumulator 354, the shifting/rounding unit 355, and the clipping unit 356. In other words, the SIMD calculating unit 101 according to the present invention is not limited to the one for only performing DCT processing.

Many widely different embodiments of the present invention may be constructed without departing from the spirit and scope of the present invention. It should be understood that the present invention is not limited to the specific embodiments described in the specification, except as defined in the appended claims.

What is claimed is:

1. An image processing device comprising:
an SIMD (Single Instruction stream Multiple Data stream) calculating means for performing operations, such as motion compensation, motion prediction, DCT (Discrete Cosine Transform) processing, IDCT (Inverse Discrete Cosine Transform) processing, quantization, and reverse quantization by means of a pipeline operation unit that can be program-controlled by an outside unit;
a VLC (Variable Length Code) processing means for performing variable-length encoding processing and variable-length decoding processing according to a given encoding method;
an external data interface means for performing a data transfer between the image processing device and an outside unit;
an instruction memory for holding an instruction to be processed; and
a processor means for decoding the instruction held by said instruction memory, and for performing a programmed control operation on said SIMD calculating means, said VLC processing means, and said external data interface means.

2. The image processing device according to claim 1, wherein said instruction memory is a RAM (Random Access Memory).

3. The image processing device according to claim 1, wherein said instruction memory is a ROM (Read Only Memory).
